(19) United States
(12) Patent Application Publication
(10) Pub. No.: US 2010/0134768 A1
(43) Pub. Date: Jun. 3, 2010

(54) PROJECTION EXPOSURE SYSTEM FOR MICROLITHOGRAPHY

(75) Inventors: Jochen Hetzler, Aalen (DE); Toralf Gruner, Aalen-Hofen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/623,744

(22) Filed: Nov. 23, 2009

Related U.S. Application Data
(63) Continuation of application No. PCT/EP2008/057369, filed on Jun. 12, 2008.
(60) Provisional application No. 60/934,352, filed on Jun. 13, 2007.

(30) Foreign Application Priority Data
Jun. 13, 2007 (DE) 102007027200.8

(51) Int. Cl. G03B 27/68

(52) U.S. Cl. 355/30; 355/52

(57) ABSTRACT

The disclosure relates to a projection exposure system for microlithography, which includes at least one optical system that has at least one optical element with at least two aspherical surfaces essentially arranged rigidly relative to each other.

### CROSS-REFERENCE TO RELATED APPLICATIONS

This application is a continuation of, and claims benefit under 35 USC 120 to, international application PCT/EP2008/057369, filed Jun. 12, 2008, which claims benefit of German Application No. 10 2007 027 200.8, filed Jun. 13, 2007 and U.S. Ser. No. 60/934,352, filed Jun. 13, 2007. International application PCT/EP2008/057369 is hereby incorporated by reference in its entirety.

### FIELD

The disclosure relates to a projection exposure system for microlithography, which includes at least one optical system that has at least one optical element with at least two aspherical surfaces essentially arranged rigidly relative to each other.

### BACKGROUND

Projection exposure systems for microlithography are used to produce various components having a fine structure, for example in semiconductor technology.

A projection exposure system has essentially a lighting unit and a downstream optical projection system, such as a projection lens. Via the projection lens, an object field, i.e. the structure to be projected (mask, reticle), located in the object plane is projected at the highest resolution onto an image field, such as a wafer, in the image plane.

Modern lithography systems are typically operated at high aperture and large fields, so that correction of a high light conductance factor may be involved. At the same time, the number of optical elements is desirably kept as low as possible because the price of the material of the components can be high, increased light loss and increased double reflexes can occur due to reflection at design-side refractive optical surfaces, and the installation space is often limited. A high number of optical elements therefore can have a negative effect on the cost and effectiveness of the system.

For this reason, in newer applications aspherical surfaces are sometimes used in addition to spherical surfaces, both in the optics of the lighting unit and in the lens. Aspherical surfaces have a reflective surface or refractive surface, which is usually rotationally symmetrical, but is not spherical and is not shaped so as to be planar. Aspherical surfaces are suitable for effecting optical corrections in the optical systems of the projection lens. Thus, with the aid of aspheres, projection errors, such as spherical aberration, distortion, angle-dependent opening errors, such as coma, skew spherical aberration, can be corrected. Moreover, the special optical properties of aspheres can be used. The use of an aspherical surface, for example, allows the radial change in refractive power to be varied through choosing suitable deformation for the optical element. Overall, the number of refractive or reflective interfaces can be reduced and the transmission of the system thus improved.

So-called double aspheres having at least two adjacent aspherical surfaces prove to be particularly effective at improving the projection properties and the efficiency of the optical system. The use of double aspheres can increase the transmission efficiency of the system effectively. Radial relative displacement of two adjacent aspheres enables the combined effect of the aspheres to be set and changed. In addition, distortion and spherical aberration can be corrected simultaneously. A lithography lens and a projection exposure system with a double asphere are disclosed, for example, in WO 2005/033800 A1, whose content is to be included by reference into this application.

To make available a plurality of design degrees of freedom for correcting projection errors and for improving the projection properties, the use of bilaterally aspherical lenses (so-called bi-aspheres) in particular has been proposed. Such bi-aspheres are also shown in WO 2005/033800 A1.

### SUMMARY

In certain embodiments, the disclosure provides a projection exposure system for microlithography having improved projection quality combined with lower material outlay and reduced installation space.

In some embodiments, the disclosure provides a projection exposure system for microlithography which includes at least an optical system that has at least an optical element with at least two aspherical surfaces. The at least two aspherical surfaces are essentially arranged rigidly relative to each other. In addition, the projection exposure system has a mechanism for manipulating the optical element for the purpose of changing or setting the projection properties of the optical system.

In addition to the optical system, which includes an optical projection system, such as a lithography lens, which is located between an object plane and an image plane, the projection exposure system can have one lighting/illumination unit. The lithography lens can, for example, be a catadioptrical projection lens having a double asphere with refractive or reflective surfaces which are essentially rigidly connected to each other. The optical system, however, can also be part of the lighting unit of the projection exposure system, where the lighting unit can ensure homogeneous illumination of the mask or the reticle. The optical element is built into the optical system. The mechanism for manipulating the optical element can be used to change the position of the optical element in various degrees of freedom (e.g. tilting relative to the other components of the optical system), or to change its shape, for example by deformation due to bending, heat input, etc.

Since the optical element can be manipulated after installation into the system, the projection properties can be set, changed and improved by downstream adjustment of the optical element. This possibility yields improved operational and mounting options for bi-aspheres in projection exposure systems.

The optical element has a first asphere and a second asphere, which are usually essentially rotationally symmetrical. The aspherical surfaces may have the same or different shapes.

It was recognized that it can be important for the lens to be correctly oriented with the other optical elements in the optical system as the bi-asphere is being assembled. Where the system possesses projection symmetry, the installation can be aligned roughly relative to the optical system axis. While decentering and tilting of a sphere have similar effects on the projection quality, which within normal tolerances give rise to a relatively small image error, tilting of an asphere within typical tolerances can have a bigger impact than for a spherical surface of similar shape and position. Usual tolerances are system-specific. For lithography lenses acceptable tolerances are in the order of arc seconds for tilting and of micrometers for decentering.

However, it has been recognized that decentering of the asphere can have a very pronounced effect, especially with regard to aberration effectiveness. Within normal tolerances and given comparable positions and average curvatures, mounting errors generally have the following graduated negative impact on aberration level: the least impact usually results from tilting or decentering of a spherical surface. Tilting of an aspherical surface typically has much greater detrimental effect on the aberration level. The greatest impact on the aberration level often stems from decentering of an aspherical surface.

In the case of spherical surfaces, therefore, the position of the lens during assembly can be determined by the surfaces' two centers of curvature. In the case of planar surfaces, that surface normal is determined whose point of intersection on the planar surface does not play a role due to translation symmetry. Decentering of a spherical surface is measured within the mount and, when the mount is being installed, is allowed for such that the built-in lens is aligned with the optical axis of the system. Any tilting remaining after this adjustment can generally be tolerated due to the low effectiveness of tilting of spherical surfaces on the aberration level.

Unilaterally aspherical lenses can be described by the line on which the various centers of curvature of the asphere lie and by the center point of the spherical surface. Since tilting is largely non-critical for a spherical surface, special care is taken during assembly to ensure that the asphere vertex lies on the optical axis of the system or is positioned correctly relative to the beam path. To this end, the mount may be centered during assembly. Tilting of the lens within the mount in the normal order of magnitude can usually be tolerated, as well as the decentering of the spherical surface which may happen in some circumstances due to the alignment.

For bi-aspherical lenses (which are assumed to be perfect) on the other hand, tilting in the orders of magnitude usual in the manufacturing process for the projection lens has the effect on a bi-asphere that at least one of the asphere vertexes does not lie on the optical axis or is not correctly in the beam path. Nor can any possible subsequent centering of the element in the beam path prevent a significant source of error in terms of aberration levels from occurring, namely decentering of one of the aspherical surfaces.

A strategy of attaching the lens of known vertex position in the mount, such that tilting is kept within typical tolerances, and of then positioning the mount during erection such that the asphere vertex is correctly in the beam path, i.e. on the optical axis usually, thus can fail to produce the desired result.

The projection exposure system for microlithography can therefore be equipped with a manipulator, which is suited to keeping at least one bi-asphere such that it is adjustable after installation in an optical system of the system with regard to the beam path or the optical axis. Accordingly, the optical element can, for the purpose of optimizing the projection properties of the optical system, still be adjusted overall after installation. It is possible both to adjustably attach the carrier element, for example, a mount, a lens mount, etc. to the lens, and to adjustably mount the bi-asphere in the carrier element. In particular, projection errors can be compensated through the use of the manipulators by the measurements made on the composed optical system.

A manipulator or compensator for changing the position of the optical element within the optical system can be actuated by an adjusting screw, by an electric drive or be operated by any of the mechanisms known to a person skilled in the art.

In addition to or by way of alternative to manipulators, which can effect a change in any number of degrees of movement freedom for the purpose of adjusting a bi-asphere downstream, it is possible, for example, to provide manipulators for generating a deformation (change of shape) of the optical element (for example, of the surface or for changing the mutual position of the surfaces) by bending, heat, etc. These additional manipulators can include a mechanical mechanism, Peltier elements, an irradiation device (e.g. infrared sources) or resistive heating sources.

In particular, the mechanism for manipulating the optical element have at least one manipulator for changing the position of the optical element within the optical system. Thus, with the lens installed, an adjustment can be performed using the measured system parameters. The purpose of adjustment is normally only to compensate for an assembly tilt, to compensate for tilting caused for instance by transport, to compensate for long-term changes in the attachment of the element throughout the life of the system, etc. Provision can, but generally need not, be made for multiple use for more than about ten correction cycles.

In particular, the manipulator can be configured for tilting the optical element at least about a first (rotational) axis. Of course, (production-related) tilting of the two aspheres towards each other is not compensated by this measure. However, since the tilting and decentering of an aspherical surface exert a significant influence on the aberration level, small changes in these parameters can be used to set the leverage on the optical effect of the overall system.

In some embodiments, the axis of rotation is arranged obliquely/transverse to the optical axis of the optical system, in particular essentially perpendicularly to the optical axis of the optical system.

The manipulator can be configured for tilting the optical element about at least two rotational axes, namely a first axis and a second axis. In general, there will be two non-parallel axes, both of which can be aligned perpendicularly to the optical axis.

Optionally, the rotational axes are aligned perpendicularly to each other. Bi-aspheres will be mounted such that, during the adjustment, proceeding from system measurements, they can still at least be tilted perpendicularly to each other about two axes. These axes are usually also perpendicular to the optical axis. In general, the rotational axes intersect each other and/or the optical axis. The tilting possibilities are intended primarily for compensating tilting which would negatively affect the desired projection properties of the optical system after the bi-asphere has been installed in the optical system. It is also possible to compensate tilting which occurs during transport of the mounted system or is caused by changes in the attachment of the element throughout the life cycle. As there is generally very little need for such manipulations it is sufficient as a rule to provide for a maximum of ten cycles for use of the manipulator.

The manipulator can make it possible to optimize the projection properties of the system based on system measurements of the fully mounted optical system which indicate a tilting error on the part of the bi-asphere.

In particular, the manipulator can (also) be formed for carrying out a translational movement of the optical element. The translational movement will usually be executed essentially perpendicularly to the optical axis of the optical system. Lateral displacement along the optical axis may also be provided.

Optionally, the translational movement is capable of execution obliquely/transverse to the optical axis in at least one direction, in particular essentially perpendicularly to the optical axis.

The manipulator for implementing the translational motion need generally also be mechanically designed for just a few operating cycles. In the event that the attachment of the optical element within a mount is sufficiently stable and the fixing elements of the mount on the lens are still accessible after tilting occurs, or in the event that the mount can be centered in some other way, a centering manipulator for the optical element can be totally dispensed with.

Provided that the centers of curvature of both aspheres are substantially axially aligned lines (due to high manufacturing precision). These lines, after a tilting adjustment operation, may be aligned parallel to their set position, such as an optical axis. By downstream centering of the optical element (e.g. by centering the mounting) the axially aligned lines may be brought exactly into their set position. As a result, serious image errors which might occur due to decentering of an asphere are avoided.

In a departure from the ideal bi-asphere (the ideal bi-asphere has converging, i.e. axially aligned aspherical axes) it is generally not possible to achieve axial aligning with the optical lens axis or the optical axis of the system in the case of tilted and/or decentered aspherical axes (as is frequently the case with real bi-aspheres). Instead, in this case, optimization of the image quality and a reduction in image error in the lens are achieved by targeted/controlled tilting and decentering of the bi-asphere. For example, provided that the aspheres were similarly shaped it would make sense to align the mean value of the directions of the aspherical axes axially with the lens axis. It would also be possible to align the element such that the mean value of the decenterings of the asphere vertexes to the objective lens is zero. Insofar as, in this case, the bi-asphere is produced within specified tolerances concerning deviations of the aspherical axes with respect to their position and orientation, it is possible with the aid of the projection exposure system, using measurements of the optical system, to optimize the quality of projection such that the system complies with the prescribed specifications.

In particular, the optical element can be a bi-asphere and/or a double asphere lens. The optical element can, for example, be a lens with two aspherical surfaces that are the same or different.

Optionally, the optical element can have at least a first reflecting and/or refractive asphere, and a second reflecting and/or refractive asphere. Thus, all sorts of combinations of reflecting and refracting aspheres are possible.

The mechanism for manipulating the optical element can, additionally or alternatively to the mechanism of changing the position of the optical element, have a mechanism for changing the shape of the optical element, in particular through deformation of the optical element.

The mechanism for manipulating the optical element can be a mechanism for changing/manipulating at least one surface of the optical element and/or for changing the relative position of at least one surface of the optical element relative to a further surface of the optical system. Changing the shape of the bi-asphere influences the relative positions of surfaces of the optical system, surface curvatures and/or the surface shape.

The mechanism for manipulating the optical element can be a mechanism for bending the optical element. Targeted bending may be effected for example by mechanical impact.

The mechanism for manipulating the optical element can include at least one Peltier element and/or at least one irradiation device and/or at least one resistive heating source for changing the shape of the optical element. Through targeted local heat input or dissipation, thermal expansion and thermal effects (e.g. surface effects) can, for example, be exploited in order that the optical properties of the optical system may be set.

The optical system may include an optical lens which is arranged next to the image plane. The optical lens is arranged adjacent to next to the object plane and/or the image plane, i.e. it is the optical element, particularly the lens, which is arranged closest to the object plane or image plane. Thus the lens is the last optical element, particularly the last lens, of the objective arranged within the optical path of the objective.

In certain embodiments, the optical lens is the optical element with at least two aspherical surfaces.

The optical lens may include at least one of the following group materials BaF₂, LiF, LuAG (Lu₃Al₅O₁₂), or a mixed crystal including BaF₂, LiF and/or LuAG (Lu₃Al₅O₁₂).

Protection is sought both individually and in any combination for the properties described, in particular for the described process steps and procedures which concern the installation and adjustment of the optical element.

### BRIEF DESCRIPTION OF THE FIGURES

Further advantages, characteristics and features are apparent from the following detailed description and enclosed figures, in which:

FIG. 1 shows a bi-asphere which may be built into a projection exposure system for microlithography;

FIGS. 2a, 2b, 2c show a bi-asphere which may be built into a projection exposure system for microlithography in accordance in different orientations;

FIG. 3 shows a purely refractive reduction objective; and

FIG. 4 shows a projection objective where the object-side concave mirrors and the image-side concave mirrors each have identical vertex positions and different curvatures.

### DETAILED DESCRIPTION

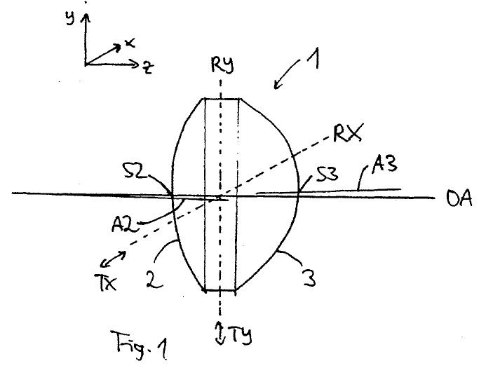

FIG. 1 shows a schematic diagram of a bi-asphere 1, which is formed as a lens with two different aspherical surfaces 2, 3. It is provided that bi-asphere 1 is already attached in a mount and located at a objective/lens of a projection exposure system. For reasons of clarity, the mount and the objective/lens are not shown. The lens 1 is part of a projection optics with a plurality of further optical elements within a projection exposure system for microlithography.

The projection exposure system has at least one manipulator (not shown), which can execute tilting of the bi-asphere 1 about an axis RX and an axis RY perpendicular thereto, both of which in turn are perpendicular to the optical axis OA of the optical system. The centers of curvature of the two aspheres 2 and 3 define the respective aspherical axes A2 and A3. The aspherical axes A2 and A3 are tilted towards each other and offset relative to each other within a specified tolerance (as a result of the production process of the bi-asphere 1 and before incorporation into the optical system).

Through tilting about the axes RX and RY, a first adjustment of the lens 1 for optimizing the projection properties of the optical system is executed using measurements of the projection properties of the optical system. The aspherical axes A2 and A3 are aligned with the optical axis of the projection system such that the projection properties overall are optimized.

The aspherical axes A2 and A3 can then be aligned by a translational after-adjustment (second adjustment), such as in directions TX and TY, such that a further optimization of the projection properties of the overall optical system is achieved.

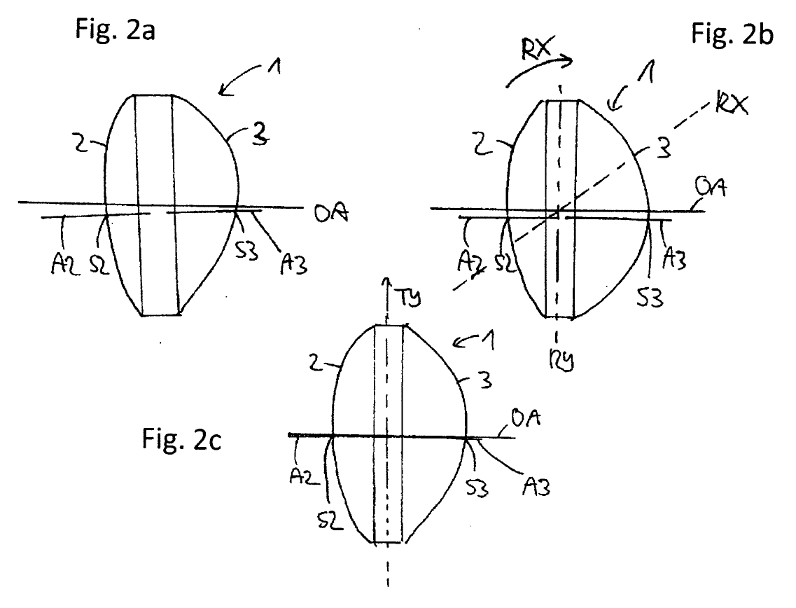

FIG. 2a shows a further bi-asphere 1 similar to the lens shown in FIG. 1 above. It is also supposed that the bi-asphere is built into a mount and arranged at a lithography lens/objective.

The bi-asphere 1 has two aspheres 2 and 3, each of which has an aspherical axis A2 and A3 and asphere vertex S2 and S3 determined by the centers of curvature. As is clear from FIG. 2a, the aspherical axes A2 and A3 of the bi-aspheres 2 and 3 in this case are axially aligned within a specified manufacturing tolerance. However, in the installed state, the axes A2 and A3 are arranged such that they are tilted and decentered relative to the optical axis of the optical projection system.

While, in the case of conventional projection exposure systems, tilting cannot be compensated after the installation of the lens, in the projection exposure system at least one manipulator is provided between the mount and the lithography lens, with the aid of which manipulator, as shown in FIG. 2b, a rotation RX about a corresponding axis RX and/or a rotation about the RY axis perpendicular thereto can be executed in order that tilting of the aspherical axes A2, A3, relative to the optical axis OA, responsive to system measurements, may be compensated.

Then, as shown in FIG. 2c, a translation TY (corresponding to TX) is executed in order that the axes A2, A3 may be aligned relative to the optical axis OA, particularly to center and/or axially align them with regard to the optical axis OA.

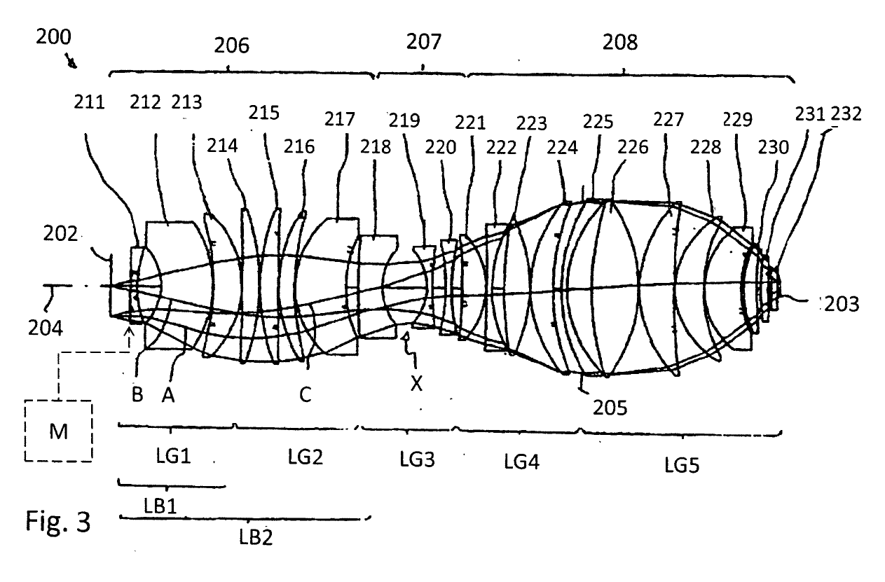

FIG. 3 illustrates a purely refractive reduction objective 200. The optical system has already been disclosed in US2007/0258134A1 (without manipulator M).

It serves the purpose of imaging a pattern, arranged in its object plane 202, of a reticle or the like into an image plane 203 on a reduced scale, for example, on the scale 4:1. The system is a rotationally symmetrical system with five consecutive lens groups L1 to L5 that are arranged along the optical axis 204 perpendicular to the object plane and image plane. Details of the system are disclosed in US2007/0258134A1 whose content is incorporated herein by reference.

The first lens group LG1 following the object plane 202 is substantially responsible for expanding the light bundles in the first belly 206. A negative lens 211 with a convex entrance side relative to the object plane and a concave exit side on the image side is provided as first lens directly following the object plane 202. Both lens surfaces of lens 211 are aspheric surfaces, and so the negative lens 211 is also denoted as a “double aspheric lens” or “biasphere”.

The optical imaging system 200 (that may also denoted as a “lithography objective”) has at least two aspheric surfaces that are provided at one and the same lens 211 such that both the entrance surface of the lens, and the exit surface of the lens are aspherically curved. Such a lens is also denoted as a “biasphere”.

The biasphere 211 in the system 200 may be equipped with a manipulator M for manipulating the biasphere 211 for changing the projection properties of the optical system 200. The manipulator M may include, for example, an actuator for changing the position of the optical element 211 within the optical system 200. It may include mechanism for tilting the optical element 211 about optical axes which are arranged perpendicularly to the optical axis 204 of the optical system 200. Furthermore, the manipulator M may include a mechanism for carrying out a translational movement of the optical element 211 in directions perpendicularly to the optical axis 204.

The manipulator M may include a mechanism for deforming the surface of the biosphere 211, e.g. by mechanical force or by heat/cooling the element 211 by a Peltier element and/or an irradiation device and/or a resistive heating source.

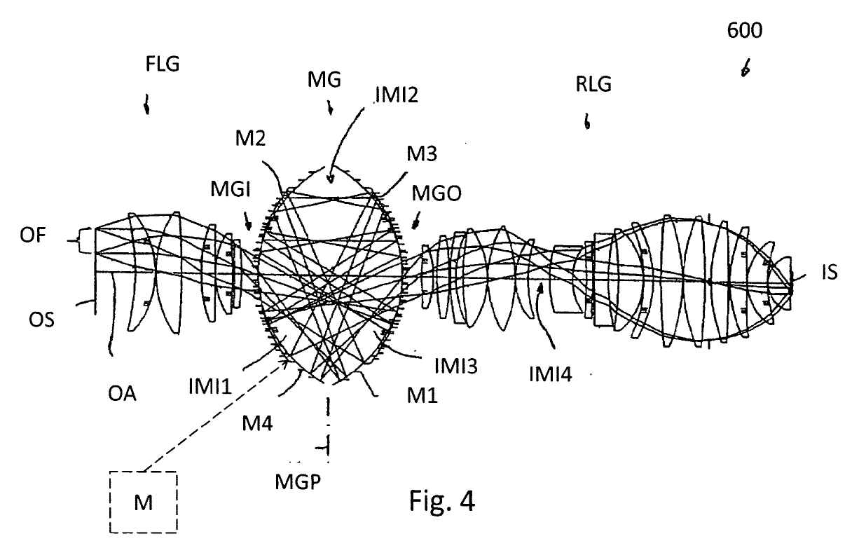

FIG. 4 illustrates a projection objective 600 of a projection exposure system for microlithography. The optical system has already been disclosed in WO2005/098505 A1 (without manipulator M) whose content is incorporated herein by reference. In FIG. 4, the vertex positions of the object-side mirrors M2 and M4 on the one hand and of the image-side mirrors M1 and M3 on the other hand are identical. Therefore, the object-side mirrors having their mirror surfaces facing to the image-side have the same axial position, but differ in surface curvature. Likewise, the image-side mirrors having the mirror surfaces facing to the object have the same axial position, but differ in surface curvature. The aspheric surfaces are positioned on rigidly coupled mirror bodies. The mirrors M2+M4 and M1+M3, respectively, are rigidly coupled. Each of these groups may be equipped with a manipulator M. In FIG. 4 only one manipulator M is indicated. The manipulators (e.g. manipulator M) may particularly be configured to tilt M1+M3 and M2+M4, respectively. The manipulator M may, however, be configured to provide various kinds of manipulations as described in this application.

With the aid of the system, it is possible, with the bi-asphere 1 already mounted at the objective/lens, using the projection parameters from the system itself, to perform an alignment of the lens 1, in particular tilting, for the purpose of optimizing the projection parameters of the lithography lens.

What is claimed is:

1. A projection exposure system, comprising:
an optical system comprising an optical element having at least two aspherical surfaces, the at least two aspherical surfaces being rigidly arranged relative to each other; and
a mechanism configured to manipulate the optical element to change projection properties of the optical element,
wherein the projection exposure system is configured to be used in microlithography.

2. The projection exposure system in accordance with claim 1, wherein the mechanism comprises a manipulator configured to change a position of the optical element.

3. The projection exposure system in accordance with claim 2, wherein the manipulator is configured to tilt the optical element about a first axis.

4. The projection exposure system in accordance with claim 3, wherein:
the optical system has an optical axis; and
the first axis is oblique to the optical axis of the optical system, the first axis is transverse to the optical axis of the optical system, and/or the first axis is perpendicular to the optical axis of the optical system.

5. The projection exposure system in accordance with claim 2, wherein the manipulator is configured to tilt the optical element about a first axis and a second axis.

6. The projection exposure system in accordance with claim 5, wherein the first axis is perpendicular to the second axis.

7. The projection exposure system in accordance with claim 2, wherein the manipulator is configured to translate the optical element.

8. The projection exposure system in accordance with claim 2, wherein:
the optical system has an optical axis; and
the manipulator is configured to translate the optical element oblique to the optical axis, the manipulator is configured to translate the optical element transverse to the optical axis, or the manipulator is configured to translate the optical element perpendicular to the optical axis.

9. The projection exposure system in accordance with claim 1, wherein the optical element is a bi-asphere.

10. The projection exposure system in accordance with claim 1, wherein the at least two aspheres include first and second aspheres, the first asphere is reflective and/or refractive, and the second asphere is reflective and/or refractive.

11. The projection exposure system in accordance with claim 1, wherein the mechanism is configured to change a shape of the optical element, and/or the mechanism is configured to deform the optical element.

12. The projection exposure system in accordance with claim 1, wherein the mechanism is configured to change a surface of the optical element, and/or the mechanism is configured to change a position of the surface of the optical element relative to a surface of the optical system.

13. The projection exposure system in accordance with claim 1, wherein the mechanism is configured to bend the optical element.

14. The projection exposure system in accordance with claim 1, wherein the mechanism comprises a Peltier element, an irradiation device, and/or a resistive heating source.

15. The projection exposure system in accordance with claim 1, wherein the optical system comprises an optical lens which is arranged next to an object plane of the optical system and/or an image plane of the optical system.

16. The projection exposure system in accordance with claim 15, wherein the optical lens is the optical element having the at least two aspherical surfaces.

17. The projection exposure system in accordance with claim 15, wherein the optical lens comprises at least one material selected form the group consisting of BaF₂, LiF, Lu₃Al₅O₁₂, a mixed crystal comprising BaF₂, a mixed crystal comprising LiF, and a mixed crystal comprising Lu₃Al₅O₁₂.

18. The projection exposure system according to claim 1, wherein the optical system is a projection lens.

19. The projection exposure system according to claim 18, further comprising an illumination unit.

20. The projection exposure system according to claim 1, wherein the optical system is an illumination unit.
